(19) United States
(12) Patent Application Publication
(10) Pub. No.: US 2018/0058647 A1
(43) Pub. Date: Mar. 1, 2018

(54) REMOVABLE DESK LAMP

(71) Applicant: Guangdong BESTEK E-commerce Co., Ltd., Shenzhen (CN)

(72) Inventors: WEI HE, Shenzhen (CN); Lingbin LI, Shenzhen (CN)

(21) Appl. No.: 15/644,773

(22) Filed: Jul. 8, 2017

Related U.S. Application Data
(63) Continuation of application No. PCT/CN2016/103681, filed on Oct. 28, 2016.

(30) Foreign Application Priority Data
Jun. 22, 2016 (CN) 201610455312.0

(51) Int. Cl. F21L 4/08; F21S 6/00; F21V 23/06; F21V 21/26; F21V 21/116

(52) U.S. Cl. CPC F21L 4/08; F21S 6/003; F21Y 2103/10; F21V 21/26; F21V 21/116; F21V 23/06

(57) ABSTRACT

A removable desk lamp includes a base, a lamp post, and a lamp holder. A bottom end of the lamp post is engaged with the base, and a top end of the lamp post has a plurality of first terminals. The lamp holder includes a housing, a lighting unit arranged in the housing, a rechargeable battery arranged in the housing. An end of the housing is engaged with the top end of the lamp post in a pluggable state or in an unpluggable state and including a plurality of second terminals. When the end of the housing is engaged with the top end of the lamp post, the first terminals abuts against and electrically connects with the second terminals, the lighting unit and the rechargeable battery are supplied power via the first terminals; when the end of the housing is disengaged from the top end of the lamp post, the first terminals are disconnected from the second terminals, the rechargeable battery supplies power to the lighting unit.

### BACKGROUND

### 1. Technical Field

The present disclosure generally relates lighting equipments, and especially relates to a removable desk lamp.

### 2. Description of Related Art

Desk lamp is a kind of household appliance used for lighting in people's life. It is mainly placed on the writing desk or dining table for lighting. The light radiation range of the desk lamp is relatively small and concentrated, so that the light of the whole room cannot be influenced. The light radiation range of the desk lamp is arranged around the desk lamp, to facilitate reading, studying, and saving energy.

Traditionally, a desk lamp includes a base, a lamp post connected with the base, and a lamp holder connected with the lamp post. The lamp holder is supplied power by a power supply in the base. The traditional desk lamp has a single function and can only be used as a desk lamp, and cannot satisfy the humanization requirement of people.

### SUMMARY

The disclosure relates to a removable desk lamp which, in a way, may solve at least one technology problem provided in the related art above.

In one aspect, the removable desk lamp according to an exemplary embodiment of the present disclosure includes a base, a lamp post, and a lamp holder. A bottom end of the lamp post is engaged with the base, and a top end of the lamp post has a plurality of first terminals. The lamp holder includes a housing, a lighting unit arranged in the housing, a rechargeable battery arranged in the housing. An end of the housing is engaged with the top end of the lamp post in a pluggable state or in an unpluggable state and including a plurality of second terminals. When the end of the housing is engaged with the top end of the lamp post, the first terminals abuts against and electrically connects with the second terminals, the lighting unit and the rechargeable battery are supplied power via the first terminals; when the end of the housing is disengaged from the top end of the lamp post, the first terminals are disconnected from the second terminals, the rechargeable battery supplies power to the lighting unit.

Wherein the top end of the lamp post defines a receiving room defining an opening to receive the first terminals, the end of the housing comprises an inserting portion which inserts into the receiving room through the opening, the second terminals is embedded in the inserting portion.

Wherein the housing has a long strip shape, and the inserting portion extends along a lengthwise direction of the housing.

Wherein the inserting portion defines a guiding groove extending along the lengthwise direction of the housing, a plurality of guiding ribs are arranged within an inner wall of the receiving room to be co-operative the guiding groove.

Wherein the inserting portion defines a hanging hole.

Wherein the lamp post includes:

a supporting pole, a bottom end of the supporting pole connected with the base; and

a pivoting pole, wherein a first end of the pivoting pole is pivotally engaged with a top end of the supporting pole through a pivoting member, and a second end of the pivoting pole defines the receiving groove.

Wherein the pivoting member comprising:

a first cover, an end of the first cover engaged with the first end of the pivoting pole;

a second cover, an end of the second cover engaged with the top end of the supporting pole;

a shaft coaxially arranged with the pivoting pole and the supporting pole, and comprising a locating portion and a thread portion, wherein the first cover is circumferentially engaged with the locating portion, the second cover is pivotally engaged with the locating portion; a friction ring is fitted around the locating portion and positioned between the first cover and the second cover, the thread portion engaged with a locating nut; and

a resilient portion coiled around the locating portion and located between the second cover and the locating nut in a compression state, so that a positive pressure is supplied among the first cover, the second cover, and the friction ring, and a friction force is generated between the first cover and the friction ring, and between the second cover and the friction ring, when the pivoting pole pivots relative to the supporting pole.

Wherein the pivoting member includes a limiting portion engaged with the locating portion and defining an aperture, the second cover comprising a projecting portion protruding along a axis direction of the second cover into the aperture, wherein the projecting portion slides within the aperture when he pivoting pole pivots relative to the supporting pole.

Wherein the pivoting member includes:

A first wear plate fitted around the shaft and located between the limiting portion and the resilient portion; and

A second wear plate fitted around the shaft, and located between the resilient portion and the locating nut.

Wherein the supporting pole includes:

A first pole body, a bottom end of the first pole body connected with the base; and

A second pole body, an end of the second pole body pivotally engaged with a top end of the first pole body along a vertical axis of the first pole body, another end of the second pole body connected with the pivoting pole via the pivoting member.

### BRIEF DESCRIPTION OF THE DRAWINGS

FIG. 1 is a perspective view of a removable desk lamp in accordance with the present invention, showing the removable desk lamp in a first state.

FIG. 2 is similar to FIG. 1, showing the removable desk lamp in a second state.

FIG. 3 is partially cross-section view of the removable desk lamp of FIG. 1.

FIG. 4 is similar to FIG. 2, showing a lamp holder of the removable desk lamp of FIG. 1 in a pivoting state.

FIG. 5 is a perspective view of a pivoting pole and a supporting pole of the removable desk lamp of FIG. 1.

FIG. 6 is perspective view of a pivoting member of the removable desk lamp of FIG. 1.

FIG. 7 is a cross-sectional view of the removable desk lamp of FIG. 2.

FIG. 8 is an enlarged view of a circle portion of FIG. 7.

The element labels according to the exemplary embodiment of the present disclosure shown as below:

base 10, lamp post 11, pivoting pole 111, receiving room 1111, first terminals 1112, second terminals, rechargeable battery 129, opening, guiding ribs 1113, receiving member 1114, supporting pole 112, second pole body 1121, first pole body 1122, lamp holder 12, housing 121, inserting portion 122, hanging hole 1221, guiding groove 1222, lighting unit 123, pivoting member 13, first cover 131, first mounting hole 1311, second cover 132, second mounting hole 1321, projecting portion 1322, shaft 133, locating portion 1331, thread portion 1332, friction ring 134, resilient portion 135, limiting portion 136, aperture 1361, locating nut 137, second wear plate 138, first wear plate 139.

### DETAILED DESCRIPTION

The disclosure is illustrated by way of example and not by way of limitation in the figures of the accompanying drawings, in which like reference numerals indicate similar elements.

In the description of the present disclosure, it needs to be understood that the terms mentioned below: “centrality”, “longitudinal”, “transverse”, “length”, “width”, “thickness”, “upper”, “below”, “front”, “back”, “left”, “right”, “vertical”, “horizontal”, “top”, “bottom”, “inner”, “outer”, “clockwise”, “anticlockwise”, etc, are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation of the present disclosure.

In addition, the terms such as “first” and “second” shown in the specification are only used to describe, but not indicated that the elements of the present disclosure is important or represented the amount of the elements. That is, the features limited by the terms of “first” and “second” may explicitly or implicitly include one or more features. In the description of the present disclosure, the meaning of the term “multiple” is not less than two unless it is specifically illustrated.

In the present disclosure, except where specifically otherwise illustrated or limited, the terms “install”, “connect”, “link” and “fix” used herein should be understood in a broad sense. Such as, the meaning may be fixedly connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure.

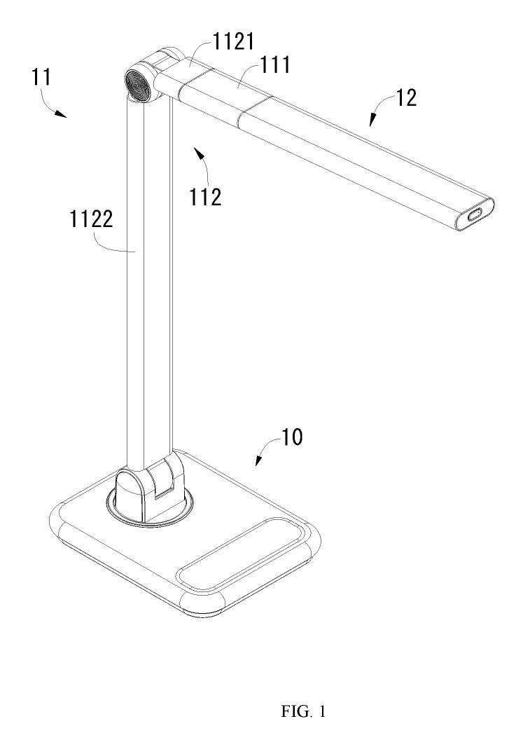

Referring to FIG. 1, the present invention discloses a removable desk lamp including a base 10, a lamp post 11, and a lamp holder 12.

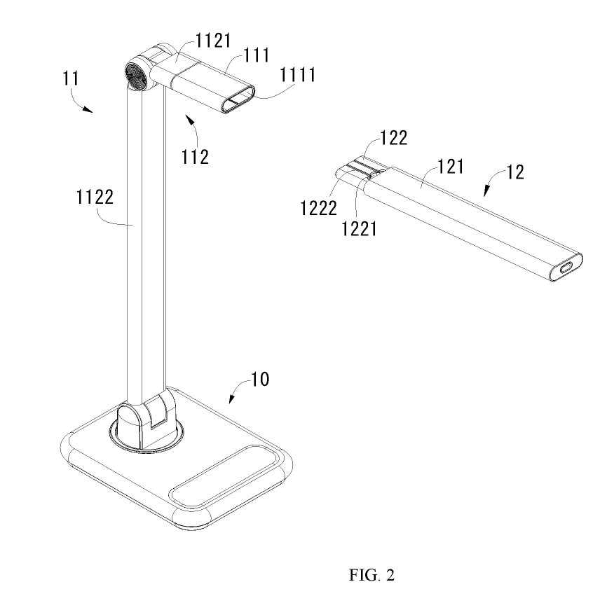

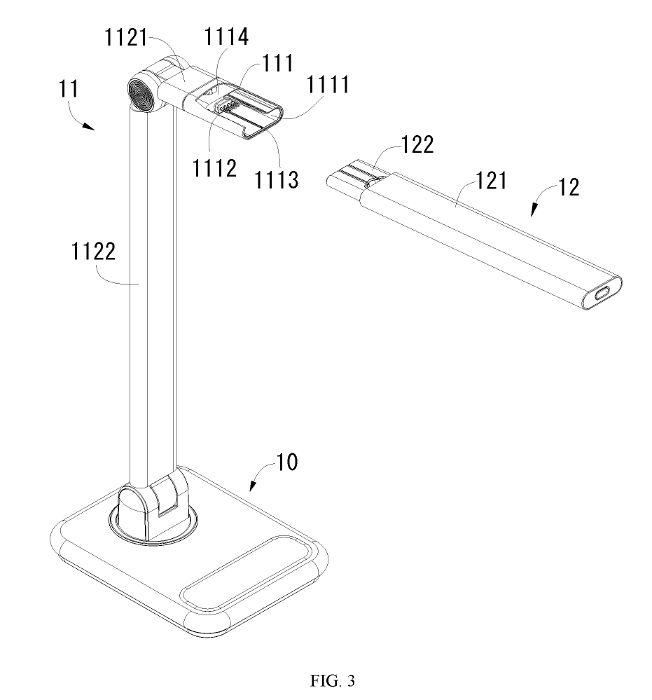

Referring to FIGS. 2-3, a bottom end of the lamp post 11 is engaged with the base 10. A top end of the lamp post 11 has a plurality of first terminals 1112. The first terminals 1112 may be connected to an external power supply, for example, the base 10 includes a power plug through wires located in the lamp post 11 to connect with the first terminals 112, and the power plug connects with the external power supply to supply power to the first terminals 1112.

In one embodiment, the lamp post 11 is a flat pipe structure.

In other embodiment, a cross-section of the lamp post 11 is in shape of circle, square, trapezium or other special shapes. In addition, the lamp post 11 may be a straight rod or a curved rod with a certain bending angle, or two or more poles is pivotally engaged with each other to form the lamp post 11.

The lamp holder 12 includes a housing 121, a lighting unit 123 arranged in the housing 121, a rechargeable battery 129 arranged in the housing 121. An end of the housing 121 engages with the top end of the lamp post 11 in a pluggable state or in an unpluggable state and includes a plurality of second terminals 1212.

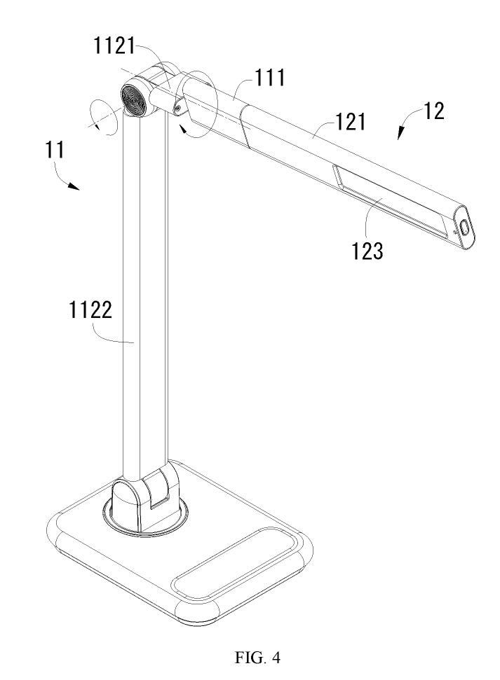

Referring to FIG. 1 to FIG. 5, in one embodiment, a structure of the housing 121 is the same as that of the lamp post 11. The lighting unit 123 is located in a bottom portion of the housing 121.

When the end of the housing 121 is engaged with the top end of the lamp post 11, the first terminals 1112 are connected with the second terminals 1212, the lighting unit 123 and the rechargeable battery 129 are supplied power via the first terminals 1112; when the end of the housing 121 is disengaged from the top end of the lamp post 11, the first terminals 1112 disconnect from the second terminals 1212, the rechargeable battery 129 supplies power to the lighting unit 123.

That is to say, the lamp holder 12 is detachably engaged with the top end of the lamp post 11. On the one hand, the lamp holder 12 includes a plurality of second terminals corresponding to the first terminals 1112. When the lamp holder 12 is engaged with the top end of the lamp post 11, the first terminals 1112 are electrically connected with the second terminals, the lighting unit 123 is supplied power via the first terminals 1112 electrically connected with the external power supply. The lighting unit 123 includes a driving circuit and a LED lamp. The driving circuit converts the external power supply into the direct current, and then supplies power for the LED lamp, so that the LED lamp works normally. On the other hand, the rechargeable battery is arranged in the lamp holder 12, and the rechargeable battery is a standby power source. When the lamp holder 12 is disengaged from the top end of the lamp post 11, the first terminals 1112 disconnect from the second terminals, the rechargeable battery supplies power to the lighting unit 123, so that the lighting unit 123 work normally.

According to the removable desk lamp, the lamp holder 12 is engaged with the lamp post 11 in the pluggable state or the unpluggable state, when the lamp holder 12 is engaged with the top end of the lamp post 11, the first terminals 1112 of the lamp post 11 are connected with the second terminals of the lamp holder 12, the lighting unit 123 is supplied power and the rechargeable battery is recharged via the first terminals 1112. When the lamp holder 12 is disengaged from the top end of the lamp post 11, the first terminals 1112 are disconnected from the second terminals, the rechargeable battery supplies power to the lighting unit 123. Thus, when necessary, the lamp holder 12 can be taken out from the lamp post 11 as an independent lighting tool, and can be carried by hand, so that the lamp holder 12 has the function of a flashlight and is more convenient to use.

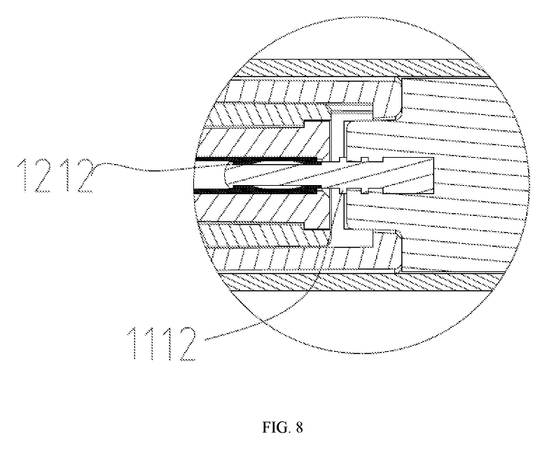

Referring to FIG. 1, FIG. 3, FIG. 5, and FIG. 8, in one embodiment, the top end of the lamp post 11 defines a receiving room 1111 to receive the first terminals 1112, and an opening is defined in an end of the receiving room 1111. The end of the housing 121 includes an inserting portion 122 which inserts into the receiving room 1111 through the opening, the second terminals 1212 is embedded in the inserting portion 122. A receiving member 1114 is arranged in the receiving room 1111, and the first terminals 1112 are mounted to the receiving member 1114. The inserting portion 122 defines a passage, and the second terminals 1212 are mounted in the passage. The inserting portion 122 is engaged with the receiving room 1111, the first terminal 1112 mounted to the receiving member 1114 are connected with the second terminals 1212 of the passage of the inserting portion 122.

That is to say, the top end of the lamp post 11 defines the receiving room 1111, and the end of the housing 121 includes the inserting portion 122 which inserts into the receiving room 1111. The lamp holder 12 is engaged with the lamp post 11 in the pluggable state or the unpluggable state via the inserting portion 122 engaged with or disengaged from the receiving room 1111. When the inserting portion 122 inserts into the receiving room 1111, the first terminals 1112 in the receiving room 1111 is electrically connected with the second terminals in the inserting portion 122. Via the inserting portion 122 engaged with the receiving room 1111, which ensures that the lamp holder 12 and the lamp post 11 are inserted more firmly and reliably, and are not easy to disengage. Meanwhile, the structure is simple, and the insertion and the removal are convenient.

Referring to FIG. 1 to FIG. 5, in one embodiment, the housing 121 has a long strip shape, and the inserting portion 122 extends along a lengthwise direction of the housing 121. The housing 121 is a flat pipe body. The inserting portion 122 is mounted to the end of the housing 121 by screws. In other embodiment, the inserting portion 122 and the housing 121 are formed integrally.

That is to say, an extending direction of the inserting portion 122 is the same as the lengthwise direction of the housing 121, which can make the structure of the removable desk lamp more simple, more concise and beautiful appearance. When in use, that the inserting part 122 can be inserted into the receiving room 1111 along the lengthwise direction of the housing 121 will be more convenient to use.

In one embodiment, the inserting portion 122 defines a guiding groove 1222 extending along the lengthwise direction of the housing 121, and a plurality of guiding ribs 1113 are arranged within an inner wall of the receiving room 1111 to be co-operative the guiding groove 1222. The inserting portion 122 defines a pair of parallel guiding grooves 1222 extending along a lengthwise thereof and located in a top surface thereof, and a guiding groove 1222 located in a bottom surface thereof. A pair of guiding ribs 1113 corresponding to the guiding grooves 1222 located in the top surface of the inserting portion 122 is arranged in an inner top wall of the receiving room 1111, and a guiding rib 1113 corresponding to the guiding groove 1222 located in the bottom surface of the inserting portion 122 is arranged in an inner bottom wall of the receiving room 1111.

During the inserting portion 122 of the lamp holder 12 insertion into the receiving room 1111 of the lamp post 11, the guiding ribs 1113 are slidably co-operative the guiding groove 1222, so that the inserting portion 122 is smoothly inserted into the receiving room 1111 under the guiding function of the guide grooves 1222 and the guide ribs 1113. At the same time, the cooperation between the guide groove 1222 and the guiding ribs 1113 also plays a positioning function to ensure that the second terminals on the inserting portion 122 is just able to form an electric contact with the first terminals 1112 of the receiving room 1111 when the inserting portion 122 is inserted into the receiving room 1111.

In one embodiment, the inserting portion 122 defines a hanging hole 1221. When the lamp holder 12 is disengaged from the lamp post 11 as an independent lighting tool, the lamp holder 12 is hanged on a wall via the hanging hole 1221, so that the lamp holder 12 is more convenient to be used alone.

In one embodiment, the lamp post 11 includes a supporting pole 112 and a pivoting pole 111. A bottom end of the supporting pole 112 is connected with the base 10. A first end of the pivoting pole 111 is pivotally engaged with a top end of the supporting pole 112 through a pivoting member 113, and a second end of the pivoting pole 111 defines the receiving groove 1111.

That is to say, the first end of the pivoting pole 111 is pivotally engaged with the top end of the supporting pole 112, so that the pivoting pole 111 can rotate around its own axis. Thus, when the lamp holder 12 is inserted into the second end of the pivoting pole 111, the lamp holder 12 can rotate together with the pivoting pole 111. Referring to FIG. 3, the housing 121 of the lamp holder 12 is a flat pipe body, and the inserting portion 122 extends along an axis direction of the housing 121. The lighting unit 123 is arranged in a bottom surface of the housing 121, the lighting unit 123 can change the illumination angle when the lamp holder 12 rotates together with the pivoting pole 111, so that the angle regulating function is provided, and the convenience of use is provided.

Referring to FIG. 1 to FIG. 6, in one embodiment, the pivoting member 13 includes a first cover 131, a second cover 132, a shaft 133, and a resilient portion 135.

The first cover 131 is engaged with the first end of the pivoting pole 111. The second cover 132 is engaged with the top end of the supporting pole 112. Referring to FIG. 5, the first cover 131 is mounted to the first end of the pivoting pole 111 via screws, and the second cover 132 is mounted to the top end of the supporting pole 112 via screws.

The shaft 133 is coaxially arranged with the pivoting pole 111 and the supporting pole 112. The shaft 133 includes a locating portion 1331 and a thread portion 1332. The first cover 131 is circumferentially engaged with the locating portion 1331. The second cover 132 is pivotally engaged with the locating portion 1331. Namely, the first cover 13 is fixed to the shaft 133, and the first cover 13 and the shaft 13 can rotate synchronously. The second cover 132 and the locating portion 1331 can rotate along the axis of the shaft 133, and the second cover 132 is fixed to the supporting pole 112, so that the supporting pole 112 can rotate relative to the shaft 133.

A friction ring 134 is fitted around the locating portion 1331 and positioned between the first cover 131 and the second cover 132. The thread portion 1332 is engaged with a locating nut 137. That is to say, the friction ring 134 is positioned between the first cover 131 and the second cover 132, and a side face of the friction ring 134 abuts against first cover 131, another side face of the friction ring 134 abuts against second cover 132. The locating nut 137 can rotate around the thread portion 1332 and move a certain distance along the axis of the shaft 133.

The resilient portion 135 is coiled around the locating portion 1331 and located between the second cover 132 and the locating nut 137 in a compression state, so that a positive pressure is supplied among the first cover 131, the second cover 132, and the friction ring 134, and a friction force is generated between the first cover 131 and the friction ring 134, and between the second cover 132 and the friction ring 134, when the pivoting pole 111 rotates relative to the supporting pole 112.

That is to say, the resilient portion 135 is located between the second cover 132 and the locating nut 137, and a length of a gap between the locating nut 137 and the second cover 132 is less than a length of the resilient portion 135 in a free state, so that the resilient portion 135 is in the compression state. Thus, the resilient portion 135 in the compression state provides a positive pressure along the axis of the shaft 133, and the positive pressure is supplied to the second cover 132, so that the second cover 132 abuts against the friction ring 134, and the friction force is generated between the first cover 131 and the friction ring 134. When the pivoting pole 111 rotates, due to the action of positive pressure, friction force is generated between the first cover 131 and the friction ring 134, and between the second cover 132 and the friction ring 134, and the frictional force acts as a drag when pivoting pole 111 rotates relative to the supporting pole 112, so that after the pivoting pole 111 is rotated to a certain angle, and can reliably stop at the position, thereby realizing the reliable regulation of the angle of the desk lamp.

Because the locating nut 137 can rotate and move relative to the thread portion 1332, the compressed distance of the resilient portion 135 is adjusted via a position of the locating nut 137 relative to the shaft 133 being adjusted, the positive pressure along the axis of the shaft 133 is adjusted, so that the friction force is adjusted between the first cover 131 and the friction ring 134, and between the second cover 132 and the friction ring 134 via the positive pressure. If the rotation between the pivoting pole 111 and the supporting pole 112 is more fastening, the locating nut 137 is driven by a wrench to move to the resilient portion 135; if the rotation between the pivoting pole 111 and the supporting pole 112 is more loose, the locating nut 137 is driven by the wrench to move away from the resilient portion 135. In addition, in the use of a certain time, if due to wear the rotation pivoting pole 111 and the supporting pole 112 become loose, the problem of loose can be solved via the locating nut 137 being driven by a wrench to move to the resilient portion 135.

In one embodiment, the resilient portion 135 can be disc spring or pressure spring, can be directly coiled around the shaft 133, and can provide greater elasticity, thereby increasing friction.

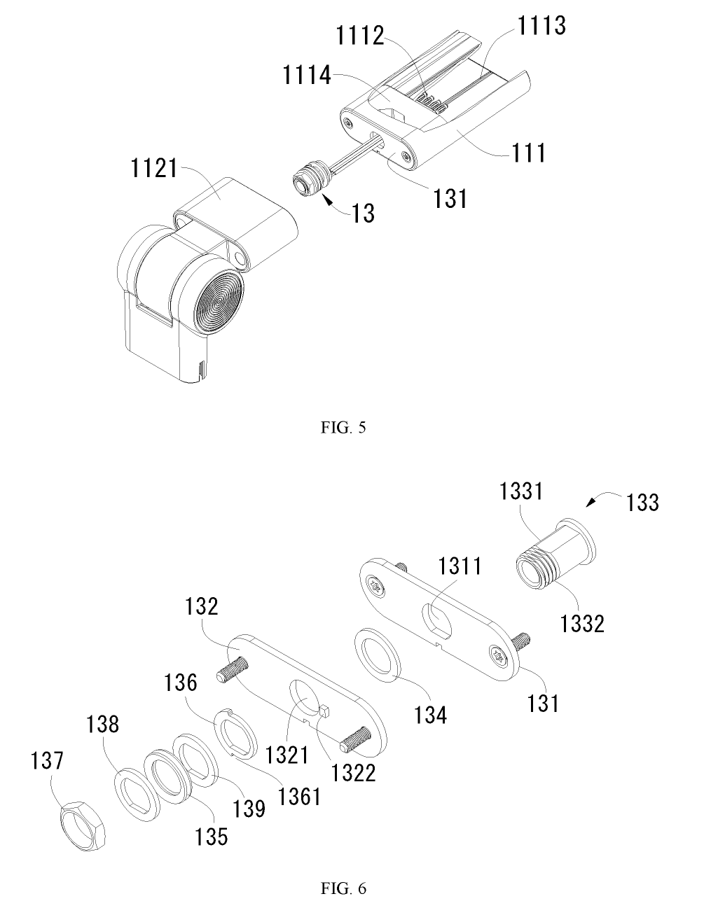

Referring to FIG. 6, a cross-section of the locating portion 1331 is non-circular. The first cover 131 defines a first mounting hole 1311, and a cross-section of the first mounting hole 131 is similar to that of the locating portion 1331. The first cover 131 is fixed to the locating portion 1331 via an interference fit between the first mounting hole 131 and the locating portion 1331, so that the first cover 131 and the shaft 133 can rotate synchronously.

The locating portion 1331 includes an arcuate face, and the second cover 132 defines a second mounting hole 1321 having a circle cross-section. The second cover 132 pivots relative to the shaft 133 via the arcuate face of the locating portion 1331 being engaged with the second mounting hole 1321.

In this embodiment, the first cover 131 and the shaft 133 are fixed via the and the interference fit between the first mounting hole 131 and the locating portion 1331, and the second cover 132 pivots relative to the shaft 133 via the arcuate face of the locating portion 1331 being engaged with the second mounting hole 1321, resulting in a simple structure, convenient assembly, and a reliable fixture and pivot.

The pivoting member 13 includes a limiting portion 136 engaged with the locating portion 1331. The limiting portion 136 defines an aperture 1361, the second cover 132 includes a projecting portion 1322 protruding along a axis direction of the second cover 132 into the aperture 1361. The projecting portion 1322 slides within the aperture 1361 when the pivoting pole 111 pivots relative to the supporting pole 112.

That is to say, the limiting portion 136 and the shaft 133 can rotate synchronously, the projecting portion 1322 slides within the aperture 1361 when the pivoting pole 111 pivots relative to the supporting pole 112. A length of the aperture 1361 determines a sliding distance of the projecting portion 1322, and the projecting portion 1322 is fixed to the second cover 132, so that the sliding distance of the projecting portion 1322 relative to the aperture 1361 determines a rotation angle range of the pivoting pole 111 relative to the supporting pole 112. In this embodiment, he sliding distance of the projecting portion 1322 relative to the aperture 1361 limits the rotation angle range of the pivoting pole 111 relative to the supporting pole 112, resulting in a simple and solid structure.

In one embodiment, the limiting portion 136 defines a third mounting hole, a cross-section of the third mounting hole is fitted to the cross-section of the locating portion 1331. The limiting portion 136 is fixed to the locating portion 1331 via an interference fit between the locating portion 1331 and the third mounting hole, so that the limiting portion 136 and the shaft 133 can rotate synchronously, resulting in a simple structure, convenient assembly, and a reliable and firm circumferential fixing.

In one embodiment, the pivoting member includes a first wear plate 139 and a second wear plate 138. The first wear plate 139 is fitted around the shaft 133 and located between the limiting portion 136 and the resilient portion 135, so that the first wear plate 139 can protect the limiting portion 136 from abrasion during the shaft 133 rotating. The second wear plate 138 is fitted around the shaft 133, and located between the resilient portion 135 and the locating nut 137, so that the second wear plate 138 can protect the locating nut 137 from abrasion during the shaft 133 rotating.

The first wear plate 139 defines a non-circle fourth mounting hole, and the first wear plate 139 is fixed to the locating portion 1331 via an interference fit between the fourth mounting hole and the shaft 133. The second wear plate 138 defines a non-circle fifth mounting hole, and the second wear plate 138 is fixed to the locating portion 1331 via an interference fit between the fifth mounting hole and the shaft 133. When the shaft 133 rotates, the first wear plate 139 and the second wear plate 138 can rotate synchronously together with the shaft 133, so that a friction force is generated between the first wear plate 139 and the resilient portion 135, and between the second wear plate 138 and the resilient portion 135, and then the rotational resistance is increased, resulting in improving the reliability of angle adjustment.

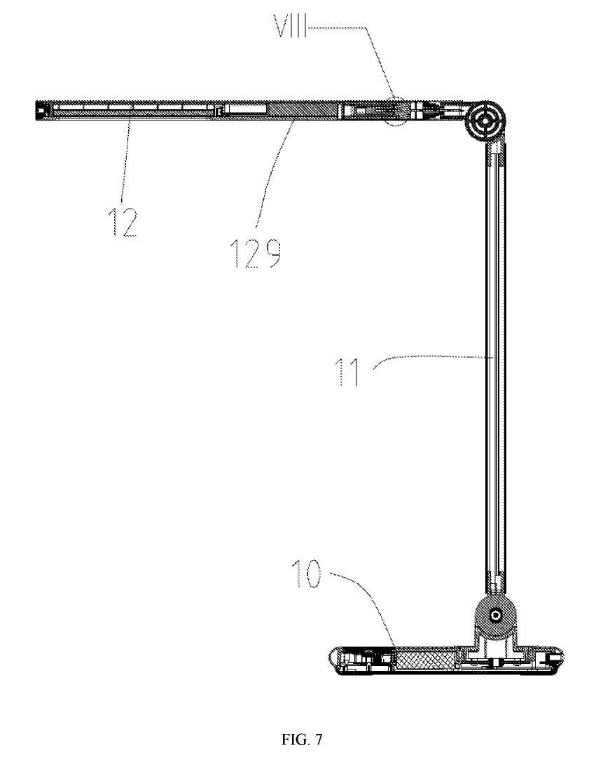

Referring to FIG. 1 to FIG. 9, in one embodiment, the supporting pole 112 includes a first pole body 1122 and a second pole body 1121. A bottom end of the first pole body 1122 is connected with the base 10. An end of the second pole body 1121 is pivotally engaged with a top end of the first pole body 1122 along a vertical axis of the first pole body 1122, another end of the second pole body 1121 is connected with the pivoting pole 111 via the pivoting member 13.

That is to say, the supporting pole 112 includes a rotating structure having the first pole body 1122 pivotally engaged with the second pole body 1121, an angel between the first pole body 1122 and the second pole body 1121 is formed when the first pole body 1122 pivots relative to the second pole body 1121. Thus, bow angle or/and elevation of the lamp holder 12 can be adjusted via adjusting the angel between the first pole body 1122 and the second pole body 1121.

Because the supporting pole 112 can adjust the bow angle or/and elevation of the lamp holder 12, and the pivoting pole 111 adjusts the horizontal tilt angle of the lamp holder 12, so that Lamp holder 12 can adjust its rotating angle according to need, and then improving convenience of use.

In the description of the specification of the present disclosure, the terms such as “an embodiment”, “some embodiments”, “an example”, “specific examples” and “some examples”, etc, are described in the specification of the present disclosure. Such description is referred to the specific characteristics, configurations, materials, or features, combined with the description of the embodiment or the example, which are included in the at least one embodiment or one example of the present disclosure. In the specification of the present disclosure, the schematic description of the terms mentioned above does not necessarily refer to the same embodiment or example. Furthermore, the specific characteristics, configurations, materials, or features of the description may be combined in any one or more embodiments or examples with a appropriate ways.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

1. A removable desk lamp, comprising:
a base;
a lamp post, a bottom end of the lamp post engaged with the base, a top end of the lamp post having a plurality of first terminals;
a lamp holder, the lamp holder comprising a housing, a lighting unit arranged in the housing, a rechargeable battery arranged in the housing, an end of the housing engaged with the top end of the lamp post in a pluggable state or in an unpluggable state and comprising a plurality of second terminals;
wherein when the end of the housing is engaged with the top end of the lamp post, the first terminals abuts against and electrically connects with the second terminals, the lighting unit and the rechargeable battery are supplied power via the first terminals; when the end of the housing is disengaged from the top end of the lamp post, the first terminals are disconnected from the second terminals, the rechargeable battery supplies power to the lighting unit.

2. The removable desk lamp as claimed in claim 1, wherein the top end of the lamp post defines a receiving room defining an opening to receive the first terminals, the end of the housing comprises an inserting portion which inserts into the receiving room through the opening, the second terminals is embedded in the inserting portion.

3. The removable desk lamp as claimed in claim 2, wherein the housing has a long strip shape, and the inserting portion extends along a lengthwise direction of the housing.

4. The removable desk lamp as claimed in claim 3, wherein the inserting portion defines a guiding groove extending along the lengthwise direction of the housing, a plurality of guiding ribs are arranged within an inner wall of the receiving room to be co-operative the guiding groove.

5. The removable desk lamp as claimed in claim 3, wherein the inserting portion defines a hanging hole.

6. The removable desk lamp as claimed in claim 1, wherein the lamp post comprising:
a supporting pole, a bottom end of the supporting pole connected with the base; and
a pivoting pole, wherein a first end of the pivoting pole is pivotally engaged with a top end of the supporting pole through a pivoting member, and a second end of the pivoting pole defines the receiving groove.

7. The removable desk lamp as claimed in claim 6, wherein the pivoting member comprising:
a first cover, an end of the first cover engaged with the first end of the pivoting pole;
a second cover, an end of the second cover engaged with the top end of the supporting pole;
a shaft coaxially arranged with the pivoting pole and the supporting pole, and comprising a locating portion and a thread portion, wherein the first cover is circumferentially engaged with the locating portion, the second cover is pivotally engaged with the locating portion; a friction ring is fitted around the locating portion and positioned between the first cover and the second cover, the thread portion engaged with a locating nut; and
a resilient portion coiled around the locating portion and located between the second cover and the locating nut in a compression state, so that a positive pressure is supplied among the first cover, the second cover, and the friction ring, and a friction force is generated between the first cover and the friction ring, and between the second cover and the friction ring, when the pivoting pole pivots relative to the supporting pole.

8. The removable desk lamp as claimed in claim 6, wherein the pivoting member comprising:
a limiting portion engaged with the locating portion and defining an aperture, the second cover comprising a projecting portion protruding along a axis direction of the second cover into the aperture, wherein the projecting portion slides within the aperture when he pivoting pole pivots relative to the supporting pole.

9. The removable desk lamp as claimed in claim 8, wherein the pivoting member comprising:
a first wear plate fitted around the shaft and located between the limiting portion and the resilient portion; and
a second wear plate fitted around the shaft, and located between the resilient portion and the locating nut.

10. The removable desk lamp as claimed in claim 6, wherein the supporting pole comprising:
a first pole body, a bottom end of the first pole body connected with the base; and
a second pole body, an end of the second pole body pivotally engaged with a top end of the first pole body along a vertical axis of the first pole body, another end of the second pole body connected with the pivoting pole via the pivoting member.
